(19) United States
(12) Patent Application Publication
(10) Pub. No.: US 2003/0149551 A1
(43) Pub. Date: Aug. 7, 2003

(54) Method and apparatus for dimensional design management

(76) Inventor: Michael V. Reasoner, Grand Blanc, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/177,275

(22) Filed: Jun. 21, 2002

Related U.S. Application Data
(60) Provisional application No. 60/354,663, filed on Feb. 5, 2002.

(51) Int. Cl. G06F 17/50

(52) U.S. Cl. 703/1

(57) ABSTRACT

A product design process automatically identifies potential component or component assembly failure areas during the early design stages to significantly reduce costs and design time. The process accomplishes this by automatically linking these potential failure areas to specific design tolerance ranges to optimize dimensional management. An initial dimensional designation for a component or component assembly includes a plurality of initial dimensional tolerances that are defined as inputs. Each input is associated with a significant and critical characteristic definition. A plurality of outputs are defined in relation to the inputs and a statistical evaluation is generated for inputs associated with each output. Each input is identified as a significant characteristic, a critical characteristic, or neither a significant nor critical characteristic based on the statistical evaluation the associated definitions. A potential cause of failure classification is identified for inputs associated with each output and at least one influential input is identified for each output based on the on the classification. A design for failure mode and effects analysis output is automatically generated that includes the data identifying the influential output.

### CROSS-REFERENCE TO RELATED APPLICATIONS

The application claims priority to U.S. Provisional Application No. 60/354,663, which was filed on Feb. 5, 2002, and which is herein incorporated by reference.

### BACKGROUND OF THE INVENTION

This invention relates to a method and apparatus for streamlining component design processes by automatically identifying critical component features during the initial design stages.

Designing a new component can be a time consuming and expensive process. Even redesigning an existing component for a different application involves significant cost and time requirements. Often several design iterations are required before a component meets the minimum design requirements. Potential component areas of failure during this design process are not mathematically identified and/or automatically ranked according to order of importance. Thus, design changes made during this design iteration process are often guesses made by engineers. For example, one potential component area of failure can be affected by many different tolerance ranges called out for that specific area of the component. Should all tolerance ranges be adjusted, should only certain tolerances be changed and if so, which ones should be changed? These questions are difficult to answer.

Often, to eliminate a potential area of failure, all tolerance ranges are identified as critical and are narrowed, which significantly increases component cost and inspection time. Further, if all or some of the tolerance ranges are narrowed certain manufacturing processes might not even be able to achieve these ranges. Thus, it is desirable to have a method that identifies, in a mathematical output format, which tolerances should be changed to eliminate or reduce the affects of the potential component area of failure.

Even when a final design is achieved, this design may not be the optimal design from a material cost or inspection investment aspect. In other words, even though a design may meet all of the fit, form, and function requirements there may be additional design improvements that can be made to further reduce cost and inspection time. Currently, there is no way to easily identify or quantify these potential additional design improvements.

It would be desirable to provide a method and apparatus that automatically optimizes component design to produce the most cost efficient component. The method and apparatus should provide a design process that automatically identifies potential component failure areas early in the design process and also automatically links these failure areas to specific design tolerances, as well as overcoming the other above mentioned deficiencies with the prior art.

### SUMMARY OF THE INVENTION

The subject invention discloses a product design process automatically identifies potential component or component assembly failure areas or outputs, which can be used during the early design stages to significantly reduce costs and design time. The process accomplishes this by automatically linking these potential failure areas or outputs to specific design tolerance ranges associated with design inputs to optimize dimensional management.

In general, the method for designing a component or component assembly includes the following steps. A plurality of inputs is generated based on a plurality of initial dimensional tolerances. At least one statistical characteristic definition is generated for each input. At least one desired output is determined based on the inputs. A statistical evaluation is generated for inputs associated with each output. The statistical evaluations are automatically compared to the statistical characteristic definitions to identify importance of the input. At least one influential input is automatically identified for each output based on the determination of step (e).

In one disclosed embodiment, an initial dimensional designation for a component or component assembly includes the plurality of initial dimensional tolerances that define the inputs. The statistical characteristic definition includes generation of a significant characteristic definition and critical characteristic definition for the inputs. A plurality of outputs are generated based on the inputs and a statistical evaluation is generated for inputs associated with each output. Further, each input is identified as a significant characteristic, a critical characteristic, or neither a significant nor critical characteristic based on the statistical evaluation and based on the significant characteristic definition and critical characteristic definition. A potential cause of failure classification is identified for inputs associated with each output and at least one influential input is automatically identified for each output based on the potential cause of failure classification. A design for failure mode and effects analysis output is automatically generated that includes at least the identification of the influential inputs associated with each output.

In one preferred embodiment, the statistical evaluation includes a determination of a number of defective parts per million for at least one output and contribution and/or sensitivity for at least one input. Also, the statistical evaluation includes the additional step of relating the number of defective parts per million for the respective output to an occurrence table to assign a numerical ranking that designates a probability of failure. This occurrence ranking is automatically associated with the respective output to identify the level of importance of the influential input.

In one preferred embodiment, the method includes the following additional steps. Determining a significant contribution criteria and/or a significant sensitivity criteria to generate the significant characteristic definition for each input and determining a critical contribution criteria and/or a critical sensitivity criteria to generate the critical characteristic definition for each input. A sensitivity calculation and/or contribution calculation are determined for at least one input associated with each output. Each input is identified as a significant characteristic, a critical characteristic, or neither a significant nor critical characteristic. A significant characteristic is identified by comparing the sensitivity and/or contribution calculations to a respective significant contribution criteria and/or a significant sensitivity criteria and is further identified by defective parts per million criteria, discussed below. A critical characteristic is identified by comparing the sensitivity and/or contribution calculations to a respective critical contribution criteria and a critical sensitivity criteria.

Further, a severity ranking is generated based on occurrence to further identify significant characteristics. Critical characteristics typically are not identified/weighted by an occurrence evaluation, however, occurrence is used to mathematically identify significant characteristics by criteria including a contribution with sensitivity weighted by occurrence. In other words, a critical characteristic automatically is assigned a high severity ranking while the severity ranking of a significant characteristic is determined based on occurrence.

Preferably, the design for failure mode and effects analysis (DFMEA) output is automatically generated as a readable table format that includes at least the following information: an identification of outputs; an identification of at least one potential failure mode for each output; designation of the influential input associated with each output as a critical characteristic, a significant characteristic, or neither a significant nor critical characteristic; a predetermined cause of failure level for each influential input; and the occurrence ranking for each influential output. Preferably, additional data includes a severity ranking based on the critical or significant characteristics and occurrence ranking. Optionally, the DFMEA output is automatically generated as an output file that can be imported into a desired software program with the output file including similar data as that which is described above.

Thus, the subject invention provides produce design process that automatically optimizes design steps to produce the most cost efficient component for a predetermined set of design requirements. The method and apparatus automatically identifies potential component failure areas early in the design process and automatically links these failure areas to specific design tolerances, which can then be appropriately adjusted. These and other features of the present invention can be best understood from the following specifications and drawings, the following of which is a brief description.

### BRIEF DESCRIPTION OF THE DRAWINGS

FIG. 1 is a perspective view, partially cut away, of an exemplary component designed according to the subject invention.

FIG. 2 is a cross-sectional view of the component shown in FIG. 1 including a dimensional tolerance designation.

FIG. 3 is an example of an occurrence table.

FIG. 4 is an example of a design for failure mode and effects analysis (DFMEA) output generated by the subject invention.

FIG. 5 is an example of a table defining severity evaluation criteria.

### DETAILED DESCRIPTION OF A PREFERRED EMBODIMENT

An example of a component assembly that is designed according to the subject invention is shown in FIG. 1. It should be understood that this assembly, as shown in FIG. 1, is simply one example of a component that could be designed according to the subject invention, as the subject inventive design process could be used to design any mechanical, electrical, or electro-mechanical component or could be used for civil engineering projects. Further, it should be understood that the subject inventive design process could be used to design a single component having component outputs specific to the component or could be used to design a component assembly or sub-assembly having component outputs specific to individual components in the assembly and/or component outputs specific to the overall assembly.

The component assembly of FIG. 1 shows a retaining mechanism 10 including a housing 12 and retaining pin 14. The housing 12 includes a central bore 16 that receives the pin 14. The bore 16 includes an increased diameter portion 18 that transitions to narrower diameter portions 20 on either side of the increased diameter portion 18. The retaining pin 14 includes a longitudinal body 22 with a resilient center flange portion 24 extending out radially from the body 22. As the retaining pin 14 is pushed into the bore 16, the flange portion 24 snaps into the increased diameter portion 18 such that the pin 14 cannot be easily withdrawn from the bore 16.

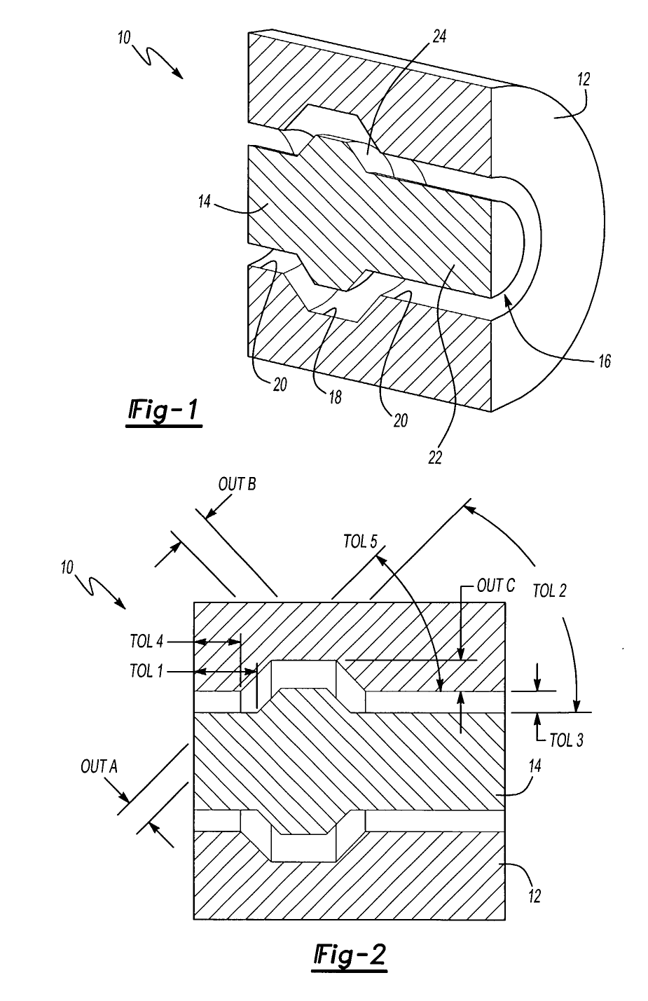

An initial dimensioning tolerance scheme for the retaining mechanism 10 is shown in FIG. 2. The initial dimensioning tolerance scheme includes a plurality of initial dimensional tolerances TOL1, TOL2, TOL3, TOL4, TOL5 that are defined as inputs. When a component, such as the retaining mechanism 10, is to be designed or redesigned there are basic rules that are required. Rules can vary according to design requirements and needs and are tied to the inputs. These rules preferably include contribution, sensitivity, occurrence and severity evaluations. These rules are used to define significant characteristics (SCs) and critical characteristics (CCs) for inputs. These SCs and CCs are linked to the production world for inspection procedures, manpower planning, and level of risk evaluations.

Further, each SC and CC has a specific Contribution requirement and/or Sensitivity requirement that must be met. As is well known in the art, Contribution relates to tolerance and Sensitivity relates to magnitude. Preferably, to qualify as either a SC or CC predetermined Contribution and Sensitivity requirements should be met, however, it should be understood that qualification as a SC or CC could involve simply meeting one of a Contribution or Sensitivity requirement. The discussion below describes SCs and CCs that must meet both Contribution and Sensitivity requirements simply as one example.

These Contribution and Sensitivity requirements are statistical evaluations and are defined by ranges or limits. To qualify as an SC for a dimension “x” identified by one of the rules, an example set of criteria may include the following: a Contribution of 60%>x>30%; a Sensitivity of 0.6>x>0.3; and a defective parts per million (DDPM)>1000. To qualify as a CC for dimension “x,” an example set of criteria may include the following: a Contribution of x>60%; a Sensitivity of x>0.6; and no DDPM requirement for qualification.

Once the list of SCs and CCs is determined, the design outputs for the component are determined for modeling. For example, if the component is a retaining mechanism, the outputs can include snap-in, engagement requirements, low lash, minimum clearance for all features, overall packaging size, etc. These outputs can be mathematically determined or graphically determined based on the various tolerances, i.e. inputs, of different dimensions of the component. These outputs can be any fit, form, or function of the component.

Preferably, the outputs are mathematically determined with equations being derived for each of the outputs based on the initial dimensioning tolerance scheme. Examples of several outputs OUTA, OUTB, OUTC are shown in FIG. 2. The equation for determining OUTA is as follows:

$$OUT A = cos ( a tan ( \frac{to11 - to14}{to13} ) - to12 ) \sqrt{{to13}^{2} + {( to11 - to14 )}^{2}}$$

Once the equations are determined and entered into the program along with the SCs and CCs requirements for the inputs, a mathematical engine generates a Contribution and a Sensitivity calculation for each input and generates a Defective Parts Per Million (DPPM) or Defective Parts Per Opportunity (DPPO) calculation for each output. These calculations are statistical determinations that are made by methods well known in the art and will not be discussed in detail. The Sensitivity and Contribution calculations are compared to the specified SC and CC rules for each of the inputs and the specified DDPM rules for each output. This comparison is then used to determine whether the input meets the definition of a SC or a CC, or to determine whether the input does not qualify for either a SC or CC.

The following example shows how this determination is made. The discussion below describes SCs and CCs that must meet both Contribution and Sensitivity requirements simply as one example, it should be understood that qualification as a SC or CC could involve simply meeting one of a Contribution or Sensitivity requirement.

Assume that the SC for a certain dimension “x” is defined by a Contribution of 60%>x>30%, a Sensitivity of 0.6>x>0.3, and a DDPM>1000. Also assume that the CC for dimension “x” is defined by a Contribution of x>60% and a Sensitivity of x>0.6. It should be understood that “x” can be any specified dimension that is related to the tolerance inputs used to determine the outputs. Also assume that OUTA, OUTB, and OUTC each include tolerances that affect the dimension “x”. The mathematical engine uses the SC, CC, and equations to generate a Contribution and Sensitivity calculation for each of the tolerances TOL1, TOL2, TOL3, TOL4, TOL5, and a DDPM calculation that affects each output equation. An example of the math modeling outputs is as follows:

OUTA

Contribution of TOL1 is 65%

Sensitivity of TOL1 is 0.7

DPPM_{(OUTA)}=1000

OUTB

Contribution of TOL3 is 40%

Sensitivity of TOL3 is 0.35

DPPM_{(OUTB)}=1000

OUTC

Contribution of TOL2 is 25%

Sensitivity of TOL2 is 0.1

DPPM_{(OUTC)}=10

Based on the SC and CC definitions above, TOL1 for OUTA would qualify as a CC because the Contribution of 65% is greater than 60% and the Sensitivity of 0.7 is greater than 0.6. TOL3 for OUTB would qualify as a SC because the Contribution of 60% is greater than 30% but less than 60%, the Sensitivity of 0.35 is greater than 0.3 but less than 0.6, and the DPPM is greater than 1000. TOL2 for OUTC would not qualify as either a SC or CC because the Contribution of 25% is less than 30%, the Sensitivity of 0.1 is less than 0.3, and the DPPM is less than 1000. Once the DPPM rule has been satisfied, then the Contribution and Sensitivity calculations are performed and reviewed to determine whether the input qualifies as a significant characteristic SC. Thus, the subject invention mathematically identifies SCs and CCs and relates this information directly back to the specific inputs.

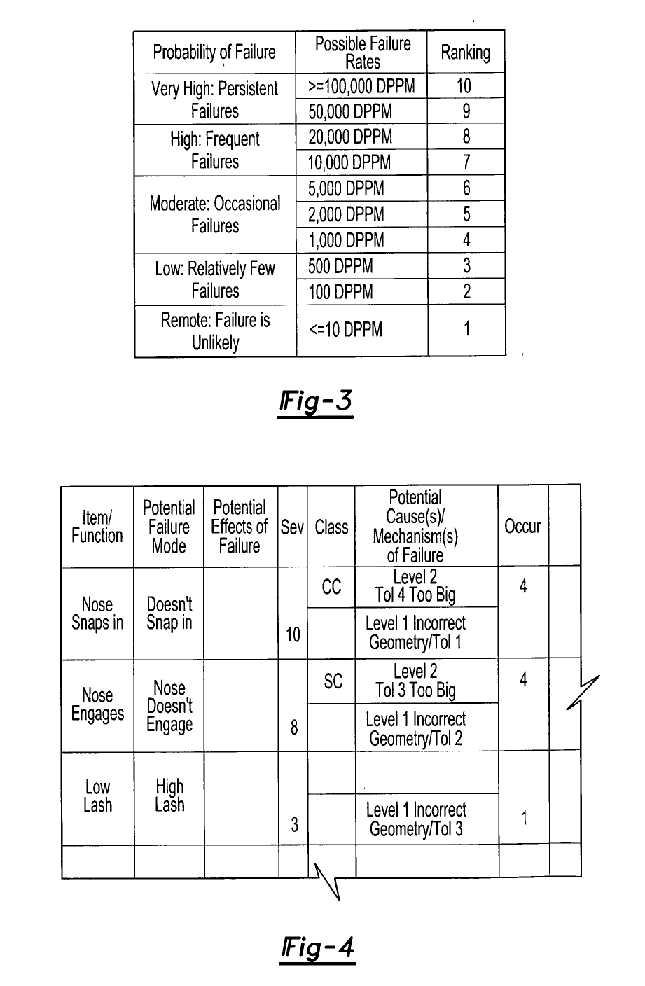

The DPPM calculation is compared to a predetermined reference chart to determine risk of failure. The reference chart is known as an Occurrence Table. An example of such a table is shown in FIG. 3. Each calculated DPPM number is compared to the table and is assigned a degree of risk. Referring to the example above, for OUTA the DPPM of 1000 is assigned a risk of 4, which indicates that failures would be occasional. The same degree of risk would also be assigned to OUTB. OUTC with a DPPM of 10 is assigned a risk of 1, which indicates that failures would be unlikely.

The subject invention then automatically exports the SCs and CCs for each input and the DDPMs for each output into a Design for Failure Mode and Effects Analysis (DFMEA) output comprising a predetermined format. Preferably, this output is generated as an output table that identifies the potential cause(s)/mechanism(s) of failure for each input associated with each output. The table preferably includes the following columns: (1) Item/Function; (2) Potential Failure Mode; (3) Potential Effects of Failure; (4) Severity; (5) Class; (6) Potential Causes/Mechanisms of Failure; and (7) Occurrence. An example of this table output format is shown in FIG. 4. It should be understood that this is just one preferred version of the table format and that the table could include fewer or more columns of information as determined by user requirements. It should also be understood that several of the columns indicated above are user defined so the number and description of columns could vary depending upon the user. Further, while an output table format is preferred, the output could be in the form of an output file that could be imported into any desired software program. The output file would include data similar to that described above.

In a typical DFMEA table output format, the Item/Function column lists the outputs in rows, e.g. snap-in, nose engages, low lash, etc. The Potential Failure Mode column is typically user defined in the initial software and lists potential failures relating to the outputs, e.g. does not snap in, nose does not engage, high lash etc. While the Potential Failure mode is typically user defined it can be optionally generated automatically.

The Potential Effects of Failure is preferably user defined and includes the result of the potential failures, e.g., component fails to operate, component noise due to vibration etc. The Potential Effects of Failure is preferably a user defined table that is incorporated into the software.

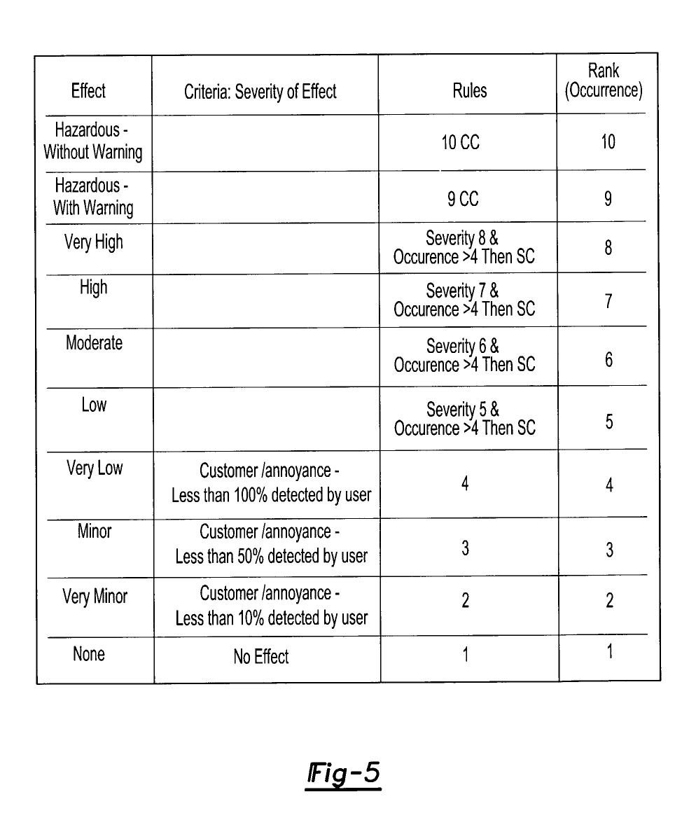

A Severity table is also defined within the software and includes a ranking system use to assign a severity ranking to the outputs. An example of a Severity Evaluation Criteria table is shown in FIG. 5. A severity ranking for each output is generated based on occurrence (generated by the DDPM evaluation for each output) to further identify significant characteristics. Critical characteristics typically are not identified/weighted by an occurrence evaluation, however, occurrence is used to mathematically identify significant characteristics by criteria including a contribution with sensitivity weighted by occurrence. In other words, a critical characteristic automatically is assigned a high severity ranking while the severity ranking of a significant characteristic is determined based on occurrence.

An example of some of the user defined columns in table of FIG. 5 include “Effects” and “Criteria: Severity of Effect.” The severity rules to determine the level of severity and to identify significant characteristics are shown in the “Rules” column and the severity ranking, as determined by the DPPM occurrence, is shown in the “Rank” column. For example, if the severity is 7 and the occurrence is greater than 4, then the input is identified as an SC, assuming any Contribution and Sensitivity requirements that may apply have also been met. The severity ranking of 7 is described as having a “High” effect. CCs typically do not need to meet an occurrence requirement. If CC requirements are met, then based on the table of FIG. 5, the associated output would automatically be assigned a 9 or 10 ranking in severity. The severity ranking of the SCs are weighted by the occurrence as shown in the “Very High” to “Low” range in the table. Thus, each output having SC identified inputs is given a severity ranking based on certain Contribution, Sensitivity, and occurrence requirements.

The Class column shows the designation of CC, SC, or neither SC nor CC, i.e. blank, for each input associated with each output. The Occurrence column is a failure/severity ranking that is determined from the DPPM and reference table as described above.

As described above, the subject invention identifies which inputs are SCs (weighted by occurrence as determined from DDPMs) and CCs, automatically associates a probability of failure occurrence ranking with each output, automatically determines which inputs are the most influential to the outputs, and automatically exports these results into the desired DFMEA table format. The Potential Causes/Mechanisms of Failure column includes the listing of the most influential inputs associated with each of the outputs. The determination of which inputs are influential is based on which inputs are identified as SCs and CCs and what the associated occurrence rank is. The subject invention has the option of listing every input associated with every output in the Potential Causes/Mechanisms of Failure column, however, to minimize the output to the DFMEA table the subject invention preferably determines which inputs are most influential to each output and only lists the inputs in the DFMEA table that have the most influence on the associated output, including all CCs and using the DPPM as the distinguishing factor for the SCs.

The subject invention further automatically assigns a predetermined cause of failure level to each of the inputs listed in the Potential Causes/Mechanisms of Failure column. An example of one predetermined cause of failure level identification system uses two levels to identify the inputs that may require tolerance changes and assigns a Level 2 or Level 1 designation. The requirements that define when a Level 2 or Level 1 designation is appropriate are predefined and can vary depending upon the component and the type of application the component or component assembly is being used in.

For example, in the DFMEA table shown in FIG. 4, the most influential input for the nose snap-in output is TOL4, which has been determined to be a CC with an occurrence ranking of 4. Further, TOL4 has been designated as a Level 2. Another input that affects the nose snap-in output is TOL1, which is designated as a Level 1 and does not qualify as either a CC or SC. Also since the output has a low occurrence ranking and no input qualified for SC or CC, the subject invention can optionally not list this input as an influential input since the occurrence value in conjunction with contribution and/or sensitivity do not satisfy the given rules.

For every tolerance/dimension input that is in an output equation, a SC/CC identifier will be assessed for qualification, an occurrence ranking will be assigned for the output, a Level 1 or 2 designation will be assigned, and a severity value will be assessed for the output based on the SC/CC/ occurrence evaluations. Not every Level 1 or 2 will be designated as a CC or SC and not every input will necessarily be shown for each output. As described above, while the subject invention does determine the SC, CC, DPPM and associated severity value, and predetermined cause of failure level, not all of this information is necessarily shown in the DFMEA output table. To reduce the number of rows displayed in the table, the subject invention automatically identifies which inputs are the most influential for each output. There may be two influential inputs, ten influential inputs, or only one influential input for any one of the outputs. Thus, the number of rows listing inputs associated with an output may vary for each output, i.e. nose snap-in may have three rows while lash may only have one row.

Thus, the subject invention automatically ties occurrence of output to the SC and CC inputs and to severity, which makes it easy to determine which dimension/tolerances inputs could be revised to reduce the occurrences. For example, because TOL4 was identified as a CC with an overall occurrence of 4 for the nose snap-in output, to reduce the occurrence TOL4 can be changed, the component can be selectively re-dimensioned, the output spec can be increased, or a design change may be implemented to possibly reduce the occurrence level associated with nose snap-in. If a simple change is made, i.e. TOL4 is made tighter, then the same nose snap-in output equation is used. The mathematical engine re-calculates, automatically identifies the influential inputs, and automatically exports this information to the DFMEA table output or into an output file for importation into a desired software program. If a more complicated change is made, i.e. the component is re-dimensioned or changed, then the equations for the output equations may have to be re-determined based on the new dimensioning scheme. Once this is done, the mathematical engine re-calculates, automatically identifies the influential inputs, and automatically exports this information to the DFMEA table output or into an output file for importation into a desired software program. Based on the information supplied in the DFMEA, the component design can be optimized to reduce cost.

Thus, the subject invention optimizes specifications and dimensioning schemes to achieve the least amount of variation for a component or component assembly design and documents this through the DFMEA. The information generated during the design optimization process can also be used to create template drawings in addition to identifying CCs and SCs in relation to the specific dimensioning scheme.

In the past, SCs and CCs were randomly selected based on historical data, personal experience, etc. These arbitrary designations of SC and CC for multiple inputs in a component or component assembly resulted in increased manufacturing costs and time/cost for inspection. To be able to mathematically identify which dimension inputs are actually SCs and CCs is a huge cost savings. To further be able to automatically associate each input with a risk associated to the outputs (i.e. occurrence) and to automatically generate a DFMEA output table incorporating this information significantly reduces design time while also providing a more accurate DFMEA based upon mathematical principles which is used by manufacturing to generate a more robust process and safer assembly procedures.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of optimizing dimensional management in a component or component assembly design process comprising the steps of:
(a) generating an initial dimensional designation for a component including a plurality of initial dimensional tolerances defined as inputs;
(b) generating a significant characteristic definition for a plurality of the inputs;
(c) generating a critical characteristic definition for a plurality of the inputs;
(d) determining a plurality of outputs based on the inputs;
(e) generating a statistical evaluation for inputs associated with each output;
(f) determining whether each input is a significant characteristic, is a critical characteristic, or does not qualify as either a significant or critical characteristic based on the statistical evaluation and based on the definitions set forth in steps (b) and (c);
(g) automatically identifying a potential cause of failure classification for inputs associated with each output;
(h) automatically identifying at least one influential input based on the classification of step (g); and
(i) automatically generating a design for failure mode and effects analysis output including at least data from step (h).

2. The method of claim 1 further including the step of assigning predetermined cause of failure levels to each influential input identified in step (h).

3. The method of claim 2 wherein step (g) further includes identifying a potential cause of failure classification for all inputs associated with each output and step (h) further includes identifying all influential inputs based on the classification of step (g).

4. The method of claim 1 further including the steps of automatically linking each influential input to each respective output and displaying the influential input and associated output in a readable format in step (i).

5. The method of claim 1 wherein steps (b) and (c) are determined by mathematical relationships.

6. The method of claim 1 wherein step (d) further includes determining the outputs either mathematically or graphically.

7. The method of claim 1 wherein the statistical evaluation of step (e) includes a determination of a potential defective number of components for each output and further including the steps of assigning a failure occurrence ranking to the potential defective number of components for each output, comparing the failure occurrence ranking to a predetermined limit, and determining at least one modified dimensional tolerance by modifying the influential input identified in step (h) to reduce the potential defective number of components when the failure occurrence ranking exceeds the predetermined limit.

8. The method of claim 7 further including the steps of generating a modified dimensional designation for the component including the at least one modified dimensional tolerance to produce a set of modified inputs and repeating steps (b) through (i).

9. The method of claim 8 including the step of repeating steps (b) through (i) until component design is optimized and the failure occurrence ranking does not exceed the predetermined limit.

10. The method of claim 1 wherein the statistical evaluation of step (e) includes a determination of a number of defective parts per million for at least one output and further including the steps of relating the number of defective parts per million for the respective output to an occurrence table to assign a numerical ranking that designates a probability of failure and automatically including this ranking for the output associated with the influential input identified in step (h) in the design for failure mode and effects analysis output generated in step (i).

11. The method of claim 1 wherein steps (b) and (c) further include generating a list of design rules applicable to the component or component assembly based on the inputs of step (a).

12. The method of claim 1 wherein step (b) further includes determining a significant contribution criteria to generate the significant characteristic definition for each input.

13. The method of claim 12 wherein step (b) further includes determining a significant sensitivity criteria to generate the significant characteristic definition for each input.

14. The method of claim 13 wherein step (c) further includes determining a critical contribution criteria to generate the critical characteristic definition for each input.

15. The method of claim 14 wherein step (c) further includes determining a critical sensitivity criteria to generate the critical characteristic definition for each input.

16. The method of claim 15 wherein the outputs of step (d) are determined by the step of generating an equation for each output with each equation including inputs that affect the respective output.

17. The method of claim 16 wherein step (e) further includes generating at least one of a sensitivity calculation or contribution calculation for at least one input associated with each output.

18. The method of claim 17 wherein step (f) further includes:
determining whether each input is a significant characteristic by comparing the contribution and/or sensitivity calculations to the significant contribution criteria and/or a significant sensitivity criteria;
determining whether each input is a critical characteristic by comparing the contribution and sensitivity calculations to the critical contribution criteria and/or a critical sensitivity criteria; and
identifying each input as a critical characteristic, a significant characteristic, or neither a critical nor significant characteristic.

19. The method of claim 18 wherein step (e) further includes generating an estimated number of defective parts for each output.

20. The method of claim 19 including the step of assigning an occurrence ranking to each output based on the estimated number of defective parts.

21. The method of claim 20 including the step of automatically linking together the occurrence ranking, the designation of critical or significant characteristic, and potential cause of failure classification for each input in the design for failure mode and effects analysis output generated in step (i).

22. The method of claim 21 including the steps of assigning predetermined cause of failure levels to each input and including the predetermined cause of failure level in the design for failure mode and effects analysis output generated in step (i).

23. The method of claim 22 wherein step (i) further includes the step of automatically generating the design for failure mode and effects analysis output in a readable table format including at least the following:
identification of outputs;
identification of at least one potential failure mode for each output;
designation of the influential input associated with each output as a critical characteristic, a significant characteristic, or neither a significant nor critical characteristic;
predetermined cause of failure level for each influential input; and
the occurrence ranking for each influential output.

24. The method of claim 23 further including the step of automatically ranking identified significant or critical characteristic influential inputs within each output based on predetermined cause of failure level and occurrence ranking.

25. The method of claim 22 wherein step (i) further includes the step of automatically generating the design for failure mode and effects analysis output in an output file importable into a software program wherein the output file includes at least the following data:
identification of outputs;
identification of at least one potential failure mode for each output;
designation of the influential input associated with each output as a critical characteristic, a significant characteristic, or neither a significant nor critical characteristic;
predetermined cause of failure level for each influential input; and
the occurrence ranking for each influential output.

26. The method of claim 1 wherein step (f) further includes generating an occurrence evaluation for each output and using the occurrence evaluation to further identify significant characteristics.

27. The method of claim 26 including the step of automatically generating a severity ranking relative to the critical characteristics and significant characteristics based on occurrence evaluation.

28. A method for designing a component or component assembly comprising the steps of:
(a) determining a plurality of inputs based on a plurality of initial dimensional tolerances set forth in an initial dimensional designation;
(b) generating at least one statistical characteristic definition for each input;
(c) determining at least one desired output based on the inputs set forth in step (a);
(d) generating a statistical evaluation for inputs associated with each output;
(e) automatically comparing the statistical evaluations to the statistical characteristic definitions to identify importance of the input; and
(f) automatically identifying at least one influential input for each output based on the determination of step (e).

29. The method of claim 28 wherein steps (d) through (e) are performed by a mathematical engine based on data received from steps (a) through (c) and wherein the method further includes the step of automatically exporting data generated by the mathematical engine into a predetermined design for failure mode and effects analysis output format.

30. The method of claim 28 wherein step (c) further includes generating at least one equation to quantify the desired output wherein the solution of the equation is affected by at least one of the inputs.

31. The method of claim 30 wherein step (b) further includes generating at least one of a significant characteristic definition or a critical characteristic definition as the statistical characteristic definition.

32. The method of claim 31 wherein each of the significant and critical characteristic definitions are further defined by at least one statistical evaluation limit and wherein step (e) further includes comparing the statistical evaluation to the statistical evaluation limit to identify the input as a critical characteristic, a significant characteristic, or neither a significant nor critical characteristic.

33. The method of claim 32 wherein step (d) further includes generating an estimated number of defective parts for each output and of assigning an occurrence ranking to each output based on the estimated number of defective parts.

34. The method of claim 32 further including the step of generating an occurrence evaluation for each output and using the occurrence evaluation to further identify significant characteristics.

35. The method of claim 34 including the step of automatically generating a severity ranking relative to the critical characteristics and significant characteristics based on occurrence evaluation.

36. The method of claim 33 further including the step of assigning predetermined cause of failure levels to each input.

37. The method of claim 36 wherein step (c) further includes generating at least one equation to quantify the desired component output wherein the solution of the equation is affected by a plurality of the inputs; and further including the step of automatically identifying and ranking a plurality of influential inputs for each output based on the determination of step (e).

38. The method of claim 37 further including the steps of comparing the occurrence ranking to a predetermined limit and determining at least one modified dimensional tolerance by modifying the influential input identified in step (f) to reduce the estimated number of defective parts when the occurrence ranking exceeds the predetermined limit.

39. The method of claim 38 including the step of repeatedly modifying initial dimensional tolerances until the occurrence ranking does not exceed the predetermined limit.

40. The method of claim 37 further including the step of automatically generating a design for failure mode and effects analysis output in a readable table format with the table format including at least the following:
identification of outputs;
identification of at least one potential failure mode for each output;
designation of the influential input associated with each output as a critical characteristic, a significant characteristic, or neither a significant nor critical characteristic;
predetermined cause of failure level for each influential input; and
the occurrence ranking for each influential input.

41. The method of claim 37 further including the step of automatically generating a design for failure mode and effects analysis output in an output file importable into a software program wherein the output file includes at least the following data:
identification of outputs;
identification of at least one potential failure mode for each output;
designation of the influential input associated with each output as a critical characteristic, a significant characteristic, or neither a significant nor critical characteristic;
predetermined cause of failure level for each influential input; and
the occurrence ranking for each influential output.

42. A computer readable medium storing a computer program, which when executed by a computer performs the steps of:
(a) receiving at least one predetermined component or component assembly output generated based on a plurality of initial dimensional tolerances defined as inputs;
(b) generating a statistical evaluation for at least one of the inputs associated with each output;
(c) automatically comparing the statistical evaluation to a statistical characteristic definition to identify importance of the input; and
(d) automatically identifying at least one influential input for each output based on the determination of step (c).

43. The computer readable medium of claim 42, which when executed by the computer performs the additional steps of:
automatically exporting data generated during steps (b) and (d) into a predetermined output format that automatically associates outputs with their respective influential inputs.

44. The computer readable medium of claim 42 wherein the component or component assembly is defined by an initial dimensional designation including the plurality of initial dimensional tolerances defined as inputs and wherein the output is comprised of at least one equation with the solution of the equation being affected by at least one of the inputs.

45. The computer readable medium of claim 44 wherein the statistical characteristic definition comprises at least one of a significant characteristic definition or a critical characteristic definition as the statistical characteristic definition and wherein each of the significant and critical characteristic definitions are further defined by at least one statistical evaluation limit, which when the computer executes step (c) further includes the step of comparing the statistical evaluation to the statistical evaluation limit to identify the input as a critical characteristic, a significant characteristic, or neither a significant nor critical characteristic.

46. The computer readable medium of claim 45, which when step (b) is executed by the computer, the computer performs the additional steps of generating an estimated number of defective parts for each output, and assigning an occurrence ranking to each output based on the estimated number of defective parts.

47. The computer readable medium of claim 46, which when step (c) is executed by the computer, the computer performs the additional steps of automatically assigning predetermined cause of failure levels to each input based on the designation of the inputs as critical or significant characteristics.

48. The computer readable medium of claim 47, wherein the at least one predetermined component or component assembly output is comprised of a plurality of predetermined component or component assembly outputs with each output being defined by an equation where the solution of each equation is affected by a plurality of the inputs which when the computer executes step (d) automatically identifies a plurality of influential inputs for each output based on the determination of step (c).

49. The computer readable medium of claim 48, which when executed by the computer performs the additional steps of:
automatically generating the predetermined output format in a design for failure mode and effects analysis table format including at least the following data:
identification of outputs;
identification of at least one potential failure mode for each output;
designation of the influential inputs associated with each output as a critical characteristic, a significant characteristic, or neither a significant nor critical characteristic;
predetermined cause of failure level for each influential input; and
the occurrence ranking for each influential input.

50. The computer readable medium of claim 48, which when executed by the computer performs the additional steps of:
automatically generating the predetermined output format in a design for failure mode and effects analysis output file importable into a software program wherein the output file includes at least the following data:
identification of outputs;
identification of at least one potential failure mode for each output;
designation of the influential inputs associated with each output as a critical characteristic, a significant characteristic, or neither a significant nor critical characteristic;
predetermined cause of failure level for each influential input; and
the occurrence ranking for each influential input.

51. The computer readable medium of claim 45 which when step (c) is executed by the computer, the computer performs the additional steps of generating an occurrence evaluation for each output and using the occurrence evaluation to further identify significant characteristics.

52. The method of claim 51 which when executed by the computer performs the additional steps of:
automatically generating a severity ranking relative to the significant and critical characteristics based on occurrence evaluation.
